(19) United States
(12) Patent Application Publication
(10) Pub. No.: US 2016/0264106 A1
(43) Pub. Date: Sep. 15, 2016

(54) Vehicle Integrated Jack Device

(71) Applicant: Alain Pierre, Huntington Station, NY (US)

(72) Inventor: Alain Pierre, Huntington Station, NY (US)

(21) Appl. No.: 14/656,310

(22) Filed: Mar. 12, 2015

(51) Int. Cl. B60S 9/04

(52) U.S. Cl. CPC B60S 9/04

(57) ABSTRACT

A vehicle integrated jack device provides independent extension of separate jack arms controlled from an interior of a vehicle. The assembly includes a vehicle having a frame and a plurality of wheels coupled to the frame. Each of a plurality of jack arms is coupled to and extendable from the frame of the vehicle. Each of the jack arms is positioned proximate an associated one of the wheels. A control unit is positioned in an interior of the vehicle. Each of the jack arms is operationally coupled to the control unit such that each jack arm is independently extendable by operation of the control unit.

### BACKGROUND OF THE DISCLOSURE

### Field of the Disclosure

The disclosure relates to jack devices and more particularly pertains to a new jack device for independent extension of separate jack arms controlled from an interior of a vehicle.

### SUMMARY OF THE DISCLOSURE

An embodiment of the disclosure meets the needs presented above by generally comprising a vehicle having a frame and a plurality of wheels coupled to the frame. Each of a plurality of jack arms is coupled to and extendable from the frame of the vehicle. Each of the jack arms is positioned proximate an associated one of the wheels. A control unit is positioned in an interior of the vehicle. Each of the jack arms is operationally coupled to the control unit such that each jack arm is independently extendable by operation of the control unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a side view of a vehicle integrated jack device according to an embodiment of the disclosure.

FIG. 2 is a bottom view of an embodiment of the disclosure.

FIG. 3 is a front view of a control unit of an embodiment of the disclosure.

FIG. 4 is a side view of an embodiment of the disclosure in use.

### DESCRIPTION OF THE PREFERRED EMBODIMENT

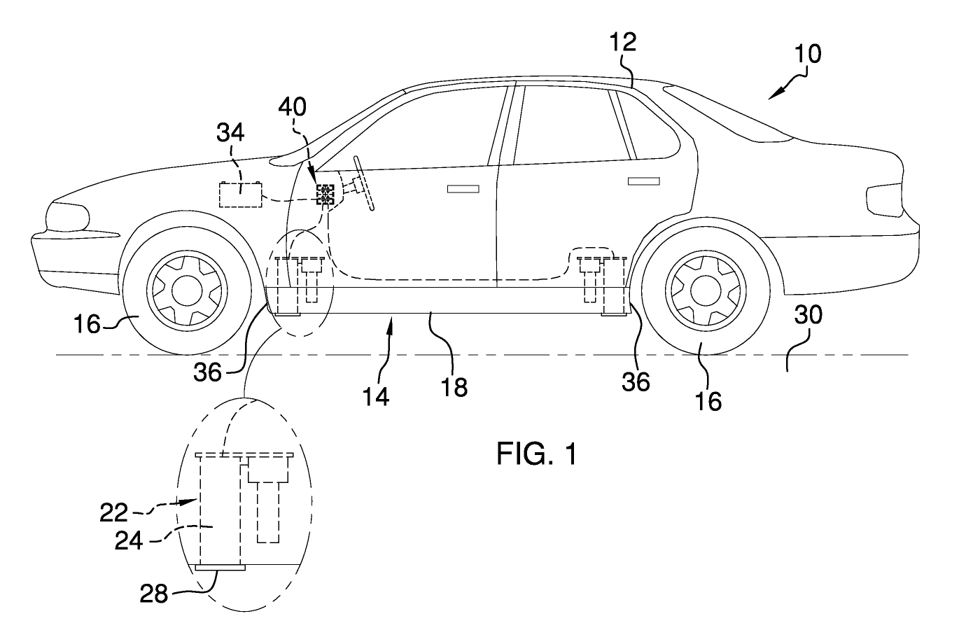

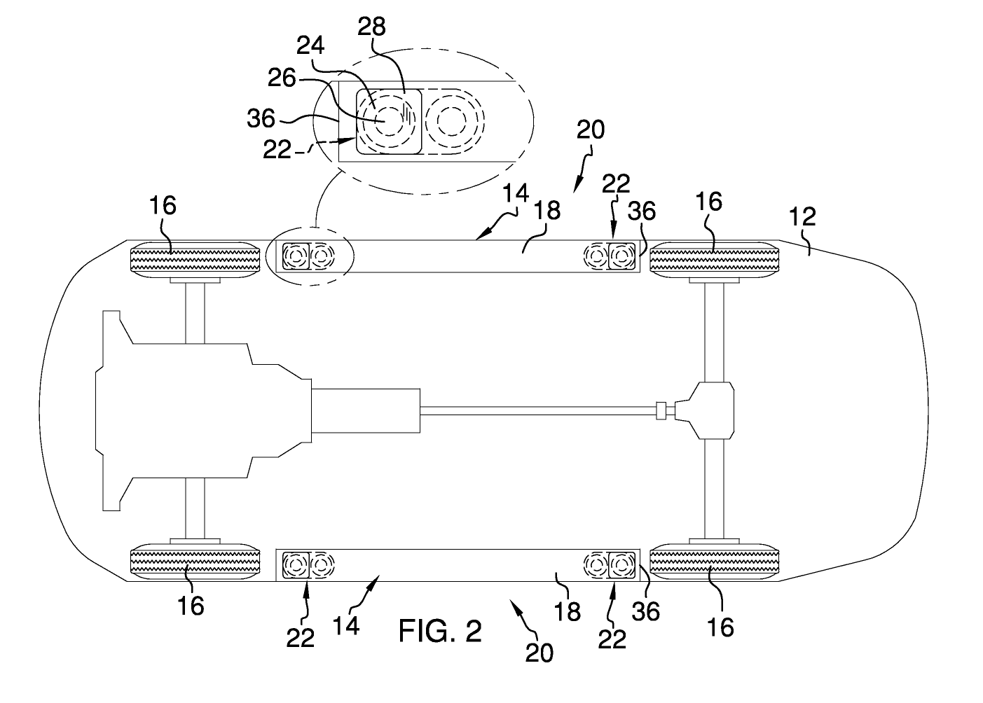

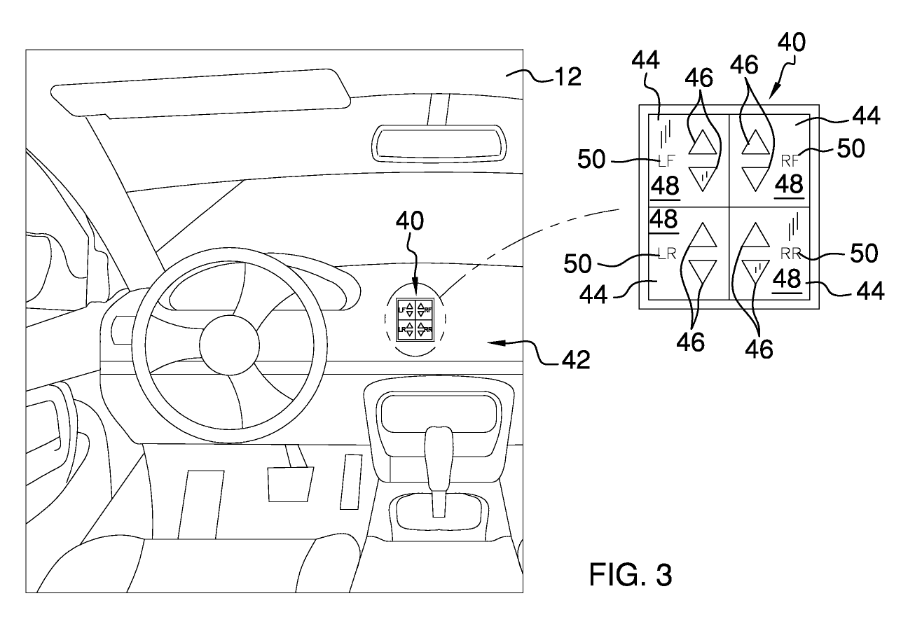

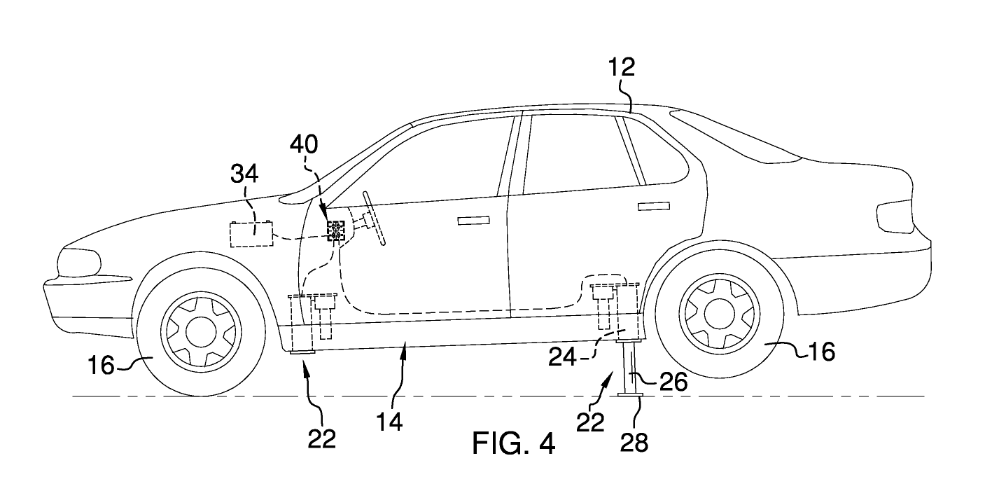

With reference now to the drawings, and in particular to FIGS. 1 through 4 thereof, a new jack device embodying the principles and concepts of an embodiment of the disclosure and generally designated by the reference numeral 10 will be described.

As best illustrated in FIGS. 1 through 4, the vehicle integrated jack device 10 generally comprises a vehicle 12 having a frame 14 and a plurality of wheels 16 coupled to the frame 14. The frame 14 includes a pair of straight lateral beams 18. Each of the lateral beams 18 extends between an associated pair of the wheels 16 along a respective side 20 of the vehicle 14. The wheels 16 are conventionally positioned at left front, left rear, right front, and right rear positions. Each of a plurality of jack arms 22 has a base section 24 coupled to the frame 14 and a nested section 26 extendable from the base section 24. A respective planar foot 28 is coupled to each nested section 26. The planar foot 28 is coupled to a distal end 32 of the nested section 26 relative to the base section 24 such that the planar foot 28 contacts a ground surface 30 and lifts the frame 14 moving the nearest wheel 16 off of the ground surface 30. Each jack arm 22 is hydraulic and may be operationally coupled to a hydraulic system powered by a battery 34 of the vehicle 12. Each of the jack arms 22 is positioned proximate an associated one of the wheels 16. Each of the jack arms 22 is further positioned adjacent to an associated end 36 of an associated one of the lateral beams 18 between the associated pair of wheels 16 wherein each jack arm 22 is configured for lifting the wheel 16 positioned proximate the jack arm 22 off of the ground surface 30.

A control unit 40 is positioned in an interior 42 of the vehicle 12. The control unit 40 may be positioned to be accessible or reachable while outside of the interior 42 of the vehicle 12. Each of the jack arms 22 is operationally coupled to the control unit 40 such that each jack arm 22 is independently extendable by operation of the control unit 40. The control unit 40 includes a plurality of buttons 44. Each button 44 corresponds to a respective one of the jack arms 22. Each button 44 includes a three position rocker switch, or the like, of conventional design including a neutral position in which the associated jack arm 22 is not engaged, an extend position in which the associated jack arm 22 is extended from the frame 14, and a retract position in which the associated jack arm 22 is retracted into the frame 14. Each button 44 has direction indicia 46 in the form of a triangle oriented to point in a direction. The direction indicia 46 is positioned on a front face 48 of the button 44 indicating a direction of movement of the associated jack arm 22 corresponding to extension and retraction of the associated jack arm 22. Each button 44 has location indicia 50 on the front face 48 of the button 44. The location indicia 50 corresponds to and identifies a location of the associated jack arm 22 relative to the frame 14 of the vehicle 12. The location indicia 50 may be abbreviations including “LF” for left front, “LR” for left rear, “RF” for right front, and “RR” for right rear. The control unit 40 is deactivated during normal operation of the vehicle 12 in a conventional manner to prevent inadvertent extension of the jack arms 22. This may include a level mechanism of conventional design to prevent extension of a jack arm 22 while the vehicle 12 is not on a sufficiently level surface for safety.

In use, manipulation of a selected one of the buttons 44 extends the associated jack arm 22 to lift the desired wheel 16 off of the ground surface 30. Each jack arm 22 is independently extendable and one or more jack arms 22 may be extended to lift one or more wheels 16 to enhance access to an underside of the vehicle 12 if desired.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle integrated jack device comprising:
a vehicle having a frame and a plurality of wheels coupled to said frame;
a plurality of jack arms, each jack arm being coupled to and extendable from said frame of said vehicle, each of said jack arms being positioned proximate an associated one of said wheels; and
a control unit, said control unit being positioned in an interior of said vehicle, each of said jack arms being operationally coupled to said control unit such that each said jack arm is independently extendable by operation of said control unit.

2. The device of claim 1, further comprising each said jack arm being hydraulic.

3. The device of claim 1, further comprising each said jack arm having a base section coupled to said frame and a nested section extendable from said base section.

4. The device of claim 3, further comprising a respective planar foot coupled to each said nested section, said planar foot being coupled to a distal end of said nested section relative to said base section.

5. The device of claim 1, further comprising said control unit including a plurality of buttons, each said button corresponding to a respective one of said jack arms, each said button comprising a three position rocker switch including a neutral position, an extend position, and a retract position.

6. The device of claim 5, further comprising each said button having direction indicia positioned on a front face of said button, said direction indicia indicating a direction of movement of said associated jack arm corresponding to extension and retraction of said associated jack arm.

7. The device of claim 5, further comprising each said button having location indicia on a front face of said button, said location indicia corresponding to and identifying a location of said associated jack arm relative to said frame of said vehicle.

8. The device of claim 1, further comprising said frame comprising a pair of straight lateral beams, each of said lateral beams extending between an associated pair of said wheels along a respective side of said vehicle, each of said jack arms being positioned adjacent to an associated end of an associated one of said lateral beams between said associated pair of wheels wherein each said jack arm is configured for lifting said wheel positioned proximate said jack arm off of a ground surface.

9. A vehicle integrated jack device comprising:
a vehicle having a frame and a plurality of wheels coupled to said frame, said frame comprising a pair of straight lateral beams, each of said lateral beams extending between an associated pair of said wheels along a respective side of said vehicle;
a plurality of jack arms, each said jack arm having a base section coupled to said frame and a nested section extendable from said base section, a respective planar foot coupled to each said nested section, said planar foot being coupled to a distal end of said nested section relative to said base section, each said jack arm being hydraulic, each of said jack arms being positioned proximate an associated one of said wheels, each of said jack arms being positioned adjacent to an associated end of an associated one of said lateral beams between said associated pair of wheels wherein each said jack arm is configured for lifting said wheel positioned proximate said jack arm off of a ground surface; and
a control unit, said control unit being positioned in an interior of said vehicle, each of said jack arms being operationally coupled to said control unit such that each said jack arm is independently extendable by operation of said control unit, said control unit including a plurality of buttons, each said button corresponding to a respective one of said jack arms, each said button comprising a three position rocker switch including a neutral position, an extend position, and a retract position, each said button having direction indicia positioned on a front face of said button, said direction indicia indicating a direction of movement of said associated jack arm corresponding to extension and retraction of said associated jack arm, each said button having location indicia on said front face of said button, said location indicia corresponding to and identifying a location of said associated jack arm relative to said frame of said vehicle.
